(19) United States
(12) Patent Application Publication
(10) Pub. No.: US 2006/0113091 A1
(43) Pub. Date: Jun. 1, 2006

(54) Multi-purpose horse shoeing tool

(76) Inventor: Bryon Millard, Grants Pass, OR (US)

Correspondence Address: Garth Janke;BIRDWELL & JANKE, LLP, Suite 1400, 1100 SW Sixth Avenue, Portland, OR, 97204, US

(21) Appl. No.: 11/317,214

(22) Filed: Dec. 22, 2005

Related U.S. Application Data
(60) Provisional application No. 60/641,301, filed on Jan. 3, 2005.

(51) Int. Cl. A01L 11/00

(52) U.S. Cl. 168/45

(57) ABSTRACT

A multi-purpose horse shoeing tool. A basic multi-purpose tool has a skeleton defined by a pair of levers pivotally mounted to each other at a pivot point defining a pivot axis, and jaw and handle ends of the levers. Clinching jaws are attached, respectively, to the jaw ends of the levers and are shaped and have respective gripping patterns cooperatively adapted for clinching shoe nails as is ordinary in the art. A hammer head is attached to a first one of the levers for using the tool as a hammer.

### RELATED APPLICATIONS

This application claims the benefit of U.S. Ser. No. 60/641,301, filed Jan. 3, 2005.

### FIELD OF THE INVENTION

The present invention relates to a multi-purpose horse shoeing tool.

### BACKGROUND

Farriers provide professional hoof care and horse shoeing services for horse owners. Such services typically include cleaning, shaping and trimming the hoof, and removing and replacing worn or broken shoes.

A horse shoe is intended to protect the plantar surface of the hoof, which would otherwise provide the horse's contact with the ground as the horse walks or runs. It is nailed to a “U” shaped surface of the hoof termed the “wall” that extends as a perimeter around the portion referred to as the “sole.” The wall intersects the “side wall” of the hoof, which extends upwardly above ground. The wall and the proximate portion of the side wall may need cleaning, shaping or trimming for receiving a horse shoe, and other portions of the animal's hoof, such as the sole, may need cleaning as well. Files and picks are often used for this purpose.

To mount a horse shoe, nails are inserted through nail holes in the shoe and the nails are hammered through the hoof with a hammer. The heads of the nails are driven into a recessed groove in the sole of the shoe, and ends of the nails extend through and out the sloping side wall of the hoof. As the size and shape of horse hooves vary, the nails are typically provided to be longer than needed. Excess length protruding from the hoof is first removed by “wringing” the ends of the nails with a wringing tool. Then, small remaining excess length protruding from the hoof is “clinched” against the side wall with a clinching tool to help prevent the nail from loosening.

Removing a shoe is often required when the shoe wears, or there is damage to the shoe or the hoof. The shoe is pried away from the hoof with a prying tool a sufficient amount to loosen the shoe so that access can be gained to the heads of the nails. The nails are then gripped at the heads with a nail pulling tool and pulled outwardly away from the hoof, using leverage against the shoe where necessary. The clinched ends of the nail may simply be pulled through.

Each of the tasks mentioned above is performed with a specialized tool suited to the particular purpose. A Farrier will carry to the location of the horse a tool-box having all of these specialized tools. The need to carry a suite of specialized tools to a location for on-site maintenance and repair is common to many fields, and is therefore easily accepted by professionals. However, owners of horses can but often will not perform hoof and shoe maintenance themselves due to the relatively high cost of obtaining and storing the necessary suite of tools.

In addition, the need to perform hoof and shoe maintenance can arise unexpectedly for an owner during a riding session, and it can happen on a trail or other remote location. Carrying a number of tools that may be required in an emergency has the serious drawback of imposing a burdensome load, both in terms of space and weight.

Accordingly, there is a need for a multi-purpose horse shoeing and hoof maintenance tool that can be used to effectively respond to at least most of the shoeing and hoof related problems likely to be encountered on a trail ride, as well as reduce the cost of horse shoeing and hoof maintenance tooling for both horse owners and Farriers.

### SUMMARY

A multi-purpose shoeing tool, such as for shoeing horses. A preferred basic multi-purpose tool according to the invention has a skeleton defined by a pair of levers pivotally mounted to each other at a pivot point defining a pivot axis, and jaw and handle ends of the levers. To this skeleton is added a pair of clinching jaws and a hammer head. The clinching jaws are attached, respectively, to the jaw ends of the levers. The handle ends are cooperatively adapted for leveraging, at the clinching jaws, a force applied to the handle ends for motivating the handle ends toward one another. The clinching jaws are shaped and have respective gripping patterns cooperatively adapted for clinching shoe nails as is ordinary in the art. The hammer head is attached to a first one of the levers, is disposed at the jaw end, and has a substantially planar hammering face defining a hammering axis. The handle ends define a handle axis that is a line of mirror image symmetry in the movements of the handle ends. The hammering axis is oriented substantially perpendicular to the handle axis as in an ordinary hammer.

Especially for use by Farriers, a wringing claw is added to the preferred basic configuration described above. The wringing claw is attached to the second one of the levers, is disposed at the jaw end, and has a hiatus defining substantially “V” shaped wringing edges oriented in a plane that is within about 5 degrees of being parallel to the handle axis.

Especially for use by horse owners, a hoof-picking/shoe-pulling member is added to the preferred basic configuration. The hoof-pick/shoe-puller member is attached to a distal end of one of the handle ends, is elongate, and has its elongate axis oriented about 80-100 degrees from the handle axis.

A pair of shoe-nail cutting elements may be added to the basic configuration. Each element of the pair is attached to a respective one of the jaw ends. The shoe-nail cutting elements have respective cutting edges and are cooperatively adapted to cut shoe nails.

A nail puller may also be added to the basic configuration. The nail-puller includes first and second nail-pulling portions. Each nail-pulling portion is attached to a respective one of the jaw ends. The nail-pulling portions in a closed configuration of the tool in which the handle ends are at positions of closest approach are cooperatively adapted to come into adjacency to provide an aperture permitting receipt of the nail shank while preventing the nail head from passing through.

Other combinations of functions and corresponding structures may be provided. For example, in alternative basic configurations providing combinations of two functions, the hammer head of the preferred basic configuration may be replaced with, for example, the wringing claw or the hoof-pick/shoe-puller member, or the clinching jaws may be replaced with the nail-puller.

### BRIEF DESCRIPTION OF THE DRAWINGS

FIG. 1 is a plan view of a preferred, multi-purpose horse shoeing tool according to the invention, providing at least five shoeing functions as described herein.

FIG. 2 is a pictorial view of a portion of the tool of FIG. 1.

FIG. 3 is a pictorial view of a multi-purpose shoeing tool according to the invention adding a nail-pulling function to the functions provided by the tool of FIG. 1.

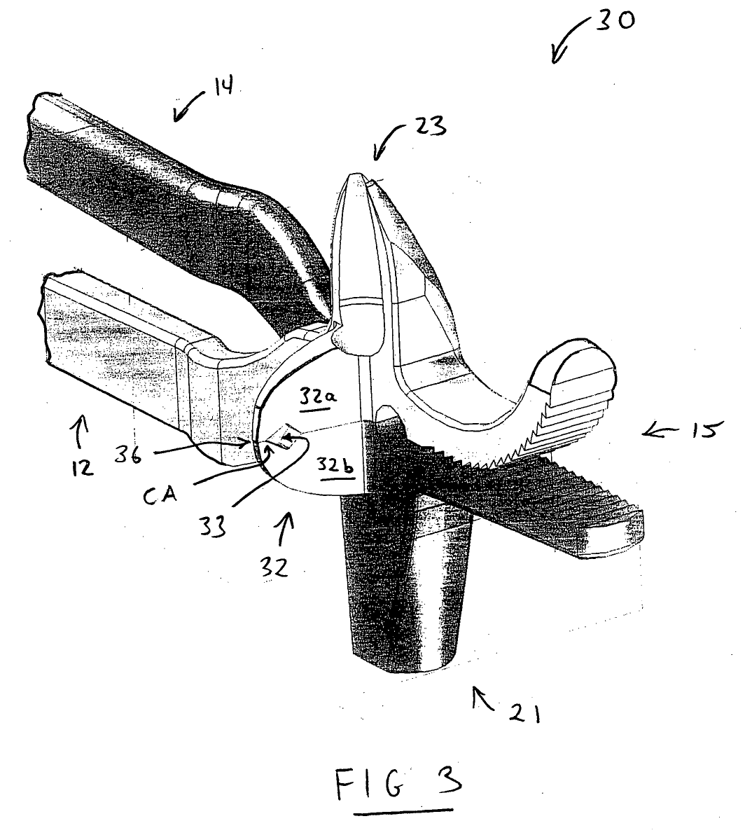

### DETAILED DESCRIPTION OF PREFERRED EMBODIMENTS

Reference will now be made in detail to specific preferred embodiments of the invention, examples of which are illustrated in the accompanying drawings. Wherever possible, the same reference numbers are used in the drawings and the description to refer to the same or like parts or dimensions.

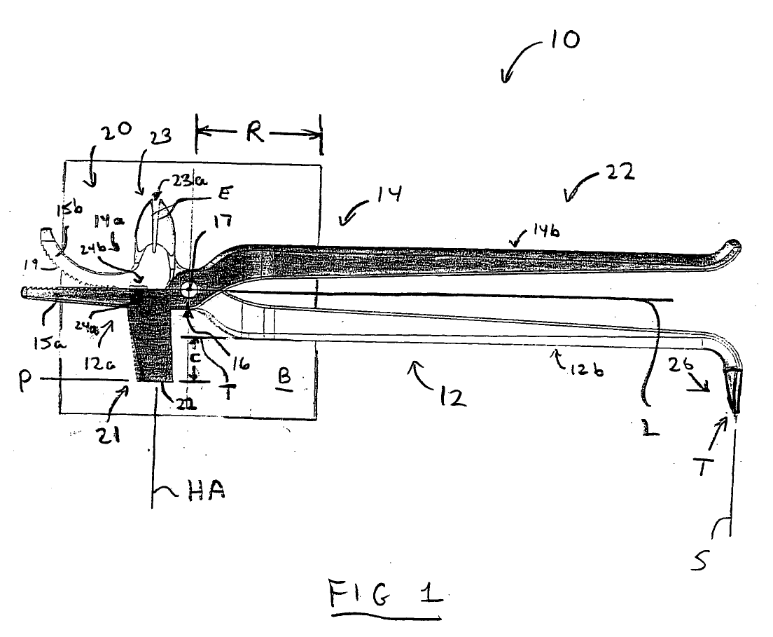

FIG. 1 shows a multi-purpose shoeing tool 10 according to the present invention. The tool 10 is intended for use in shoeing horses, but may be used for shoeing any suitable hoofed animal, such as a mule or donkey. However, horse shoeing is anticipated as being by far the more common use of the invention, and the invention is described herein in that context for that reason, it being understood that for use in other contexts suitable modifications that will be readily apparent to persons of ordinary mechanical skill may be made.

The tool 10 is preferably constructed of tool steel as is typical for hand tools, but other materials could be used in the total or partial formation of the tool, such as plastics and composite materials.

The tool 10 is a preferred embodiment of the invention, providing for five shoeing functions in a single hand-tool, namely nail-clinching, nail-hammering, nail-wringing, nail-cutting, and picking/shoe-pulling. It should be understood that additional functions may be realized by using the structures provided for alternative purposes.

The first four listed functions are for applying and removing shoe nails while the last listed function applies to removing the shoe or cleaning the hoof. All of these functional capabilities of the tool are believed to be useful for both Farriers and horse owners, but the nail-wringing function is believed to be particularly suited to the practice of Farriers, and the nail-cutting function is believed to be a potentially preferred alternative for horse owners unfamiliar with the practice of wringing.

The tool 10 has a skeleton defined by a pair of levers 12 and 14 that are pivotally mounted to each other at a pivot joint 16. To this skeleton, additional structures are attached as described below. It should be understood that the term “attached” as used herein includes attachments of separate parts, such as by connecting, bonding, or joining, as well as integral formations of the parts, which is preferred.

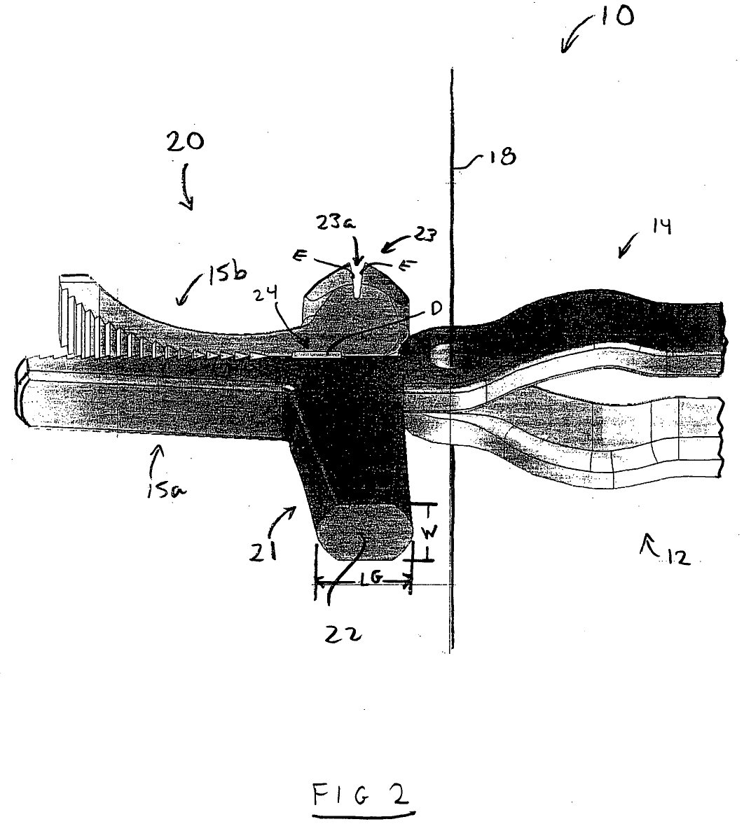

The pivot joint 16 defines a pivot point 17 and pivot axis 18 (see FIG. 2) about which the levers can pivot, the pivot axis 18 being perpendicular to the plane of FIG. 1. The pivot point and corresponding pivot axis define two ends of the tool, a jaw end 20 and a handle end 22, each end being on an opposite side of the pivot point or pivot axis. Each lever 12, 14 has an associated jaw end 12a, 14a, and handle end 12b, 14b. For purposes herein, the jaw end is referred to herein as being “above” the pivot point or axis, while the handle end is referred to as being “below” the pivot point or axis, establishing a frame of reference. This terminology is used for descriptive purposes but it should be understood that the frame of reference denoted is completely arbitrary.

As is typical in levered hand-tools, the handle ends of the levers are longer than the jaw ends to produce leverage, i.e., a larger gripping force at the jaw ends than that applied to the handle ends.

Shown is a configuration of the tool 10 in which the handle ends 12b and 14b of the pair of levers 12 and 14 are in positions of closest approach, typically though not necessarily as a result of interference between the jaw ends 12a and 14a. From their positions of closest approach in this “closed” configuration of the tool 10, the handle ends 12b and 14b can be pivoted outwardly mirror image amounts from a handle axis “L” extending through the pivot point 17, as will be readily appreciated.

Clinching jaws 14a and 15b are attached to the jaw ends 12a and 14a of the pair of levers 12 and 14. The clinching jaws are adapted for clinching shoe nails as that function is known in the art. The shape of the clinching jaws may vary as desired according to well known practice, a preferred shape being shown where the clinching jaw associated with the jaw end 12a is formed in substantially a line and the clinching jaw associated with the jaw end 14a is formed in substantially a circular arc. The clinching jaws are therefore shaped asymmetrically with respect to the handle axis “L.” Generally, the clinching jaw 15b shown as being semi-circular is at least curved outwardly, away from the handle axis “L,” while the clinching jaw 15a shown as being linear may also be relatively slightly curved outwardly in accord with known variations. Clinching jaws also share a common aspect in that they include serrations or gripping patterns adapted for gripping the protruding end of a shoe nail. Typically and preferably, serrations define teeth 19 having relatively sharp edges, as shown.

Attached to one of the jaw ends of the tool 10, here the jaw end 14a, is a hammer head 21. To provide the hammering function, the tool 10 with the hammer head 21 preferably mimics, in its closed configuration, a 10-12 oz driving hammer as known in the art. Hammers that are heavier than this tend to bend the shoe nails, while hammers that are lighter than this tend to provide insufficient driving force. The hammer head 21 has a hammering face 22 that is ordinary for the purpose and therefore is substantially planar as is typical in ordinary hammers. It is typically and preferably circular in plan, though this is not essential, but in any case is of at least approximately square dimensions, i.e., it is about as wide “W” as it is long “LG” (see FIG. 2).

The plane associated with the hammering face is preferably substantially parallel to the handle axis L. The normal to this plane defines a hammering axis “HA” that is, therefore, substantially perpendicular to the handle axis L.

To use the tool 10 either as a clinching tool or a hammer, the handle ends 12b and 14b are intended for gripping by a hand. Typically a user will grip the handle ends toward their outer extremities, i.e., toward distal ends 13 of the handle ends, to gain more leverage. To provide leverage for clinching in particular, the user will typically not grip the handle ends at locations that are within a radius “R” of the pivot point 17 that includes within its circular ambit the jaw ends. In FIG. 1, the area that will typically not be gripped is that falling within the box referenced as “B.”

For hammering, the handle ends 12b, 14b function together as the typically solid handle of an ordinary hammer. The handle axis and hammering axis are substantially perpendicular as in an ordinary hammer. Also as for an ordinary hammer, the hammer head 20 should project from the tool sufficiently from the handle, perpendicular to the handle axis. Particularly, the hand of a user gripping the handle ends as intended should be below the elevation “P” of the hammering face 22 measured with respect to the handle axis.

More particularly, it is believed that at least about ½″ clearance “C” is desirable between (a) a line “T” that is tangential to the radially outermost portion of the handle end 12b when the tool 10 is in its closed configuration and that is parallel to the handle axis “L,” and (b) the elevation “P.” It is desirable that such projection is maintained inside the box B to provide clearance around the hammer head. It is also desirable that such projection is maintained with respect to portions of the handle end 14b lying outside the box B to provide clearance for fingers. In the embodiment shown, the line T is substantially everywhere tangent to the outer surface of the handle end 12b, but this is not essential.

The present inventor has identified the hammering and the clinching functions as being a most advantageous minimal combination of the functions noted above, defining a preferred basic multi-purpose combination according to the invention.

In addition to this preferred minimal or basic combination, the tool 10 further provides a wringing claw 23 for wringing shoe nails. With the hammer head 21 attached to the jaw end 12a, the wringing claw is attached to the opposed jaw end 14a of the levers 12 and 14.

Like the clinching jaws, the wringing claw may vary in configuration as desired according to known practice for wringing shoe nails. However, the wringing claw 22 is distinguished from that of a typical claw-hammer in its orientation with respect to the handle ends 12b, 14b. That is, the wringing claw 23, according to standard practice, includes a V-shaped hiatus 23a having two relatively sharp, wringing edges “E” defining the legs of the V. The wringing edges lie in a plane that is substantially parallel (instead of perpendicular), to the handle axis “L.” The handle ends 12b, 14b thereby provide the leverage needed for turning the claw 23 to provide the desired wringing function. Preferably, this plane varies from such parallelism by less than about 5 degrees.

The aforementioned plane of the hiatus 23a is preferably substantially parallel to the hammering axis L. However, it may be noted that the claw 23 as shown could be oriented so that it is rotated about the handle axis L from the position shown in FIG. 1. For example, the claw 23 could be oriented by turning it about the axis L so that it extends upwardly, out of the plane of FIG. 1 and therefore perpendicular to the orientation shown.

The hammer head 21 and the wringing claw 23 are preferably attached to the respective jaw ends 12a and 14a directly opposite one another as shown, below the clinching jaws 15 and above but proximate to the pivot joint 16. This positioning of these parts, especially the hammer head 21, which is used for striking and is therefore subject to large impact forces, provides for best structural integrity as opposed to providing these parts as depending from the relatively slender clenching jaws 15.

The tool 10 further includes shoe nail-cutting elements 24, namely 24a, 24b attached to the respective jaw ends 12a and 14a. The nail-cutting elements 24a and 24b have sufficiently sharp cutting edges to cut shoe nails as will be readily appreciated. The cutting edges are formed in the standard manner by providing canted surfaces “D” as shown in FIG. 2 (the cutting edges are not visible in FIG. 2, lying at the bottom of the well defined by the canted sufaces). As for the hammer head 21 and the claw 23, the nail-cutting elements 24 are preferably disposed below the clinching jaws using the above-described frame of reference.

The tool 10 still further includes a hoof-picking/shoe-pulling element 26 attached to one of the handle ends, here the handle end 12b, at the distal end 13 thereof. The hoof-picking/shoe-pulling element 26 is particularly adapted for pulling the shoe from the hoof, by first forcing the element between the shoe and hoof to loosen the shoe and the shoe nails, and then prying the nails from the shoe using the shoe as a base for leverage, and picking debris from the hoof and can be used for either or both purposes.

The hoof-picking/shoe-pulling element 26 is elongate, and it is turned outwardly from the handle end so that, preferably, its elongate axis “S” extends in a direction that is about 80-100 degrees with respect to the handle axis L, which provides maximum leverage for prying.

The projecting tip “T” of the hoof-picking/shoe-pulling element 26 is preferably shaped in the form of a standard slotted screw driver blade.

FIG. 2 shows a second multi-purpose tool 30 according to the present invention that adds a nail-puller 32 to the features provided in the tool 10 as described above. The nail-puller is adapted to grab hold of nails attached to the hoof by closing around an exposed shank of the nail and catching on the nail head. The nail-puller 32 includes a first nail-pulling portion 32a attached to one of the jaw ends, here the jaw end 12a, and a second, complementary nail-pulling portion 32b attached to the other jaw end, here 12b.

In the closed configuration of the tool as shown, the nail-pulling portions 32a, 32b are adjacent one another and preferably in contact, defining a similar closed configuration of the nail-puller having a closed or sufficiently closed aperture 33 to permit receiving the nail shank while preventing the nail head from passing through. As shoeing nails are typically square in cross-section, the aperture 33 is preferably square shaped as shown, but it may have any shape sufficient to achieve its purpose. The aperture 33 in a square or otherwise cornered configuration is also preferably oriented so that a corner of the aperture “CA” is at a location of maximal projection, i.e., at a tip or apex 36 of the nail-puller, in its closed configuration. This minimizes the size of the nail puller at the point of engagement with the nail and therefore the clearance required.

The nail-puller 32 can be attached to the jaw ends 12a, 14a in any manner that allows their cooperative function and avoids interference with other functions. Preferably, the nail-puller is disposed so that it projects outwardly in a direction perpendicular to both (a) the handle axis L, and (b) the hammering axis HA.

The multi-purpose tool 30 provides for six shoeing functions in a single tool, and represents a most preferred embodiment of the invention. As mentioned above, the present inventor has identified the clinching and hammering functions as being a most advantageous minimal combination of the functions noted above, defining a preferred basic multi-purpose combination according to the invention. In addition, the inventor has identified other particular functional combinations that are believed to be particularly desirable. Particularly, for horse owners, it is believed to be particularly desirable to combine the functionality provided by the hoof-pick/shoe-puller with the functions of hammering and clinching. For Farriers, it is believed to be particularly desirable to add the wringing claw.

In accord with the invention, other functions may be provided in any combination that includes at least two, and the structures described herein can be mixed and matched as desired. For example, in some alternative basic configurations of combinations providing two functions, the hammer head of the preferred basic configuration may be replaced with, for example, the wringing claw, the hoof-pick/shoe-puller member, or the nail-puller, and the clinching jaws of the preferred basic configuration may be replaced with the nail-puller which has a similar action.

An outstanding advantage of the invention is that it provides a number of useful functions that have heretofore been provided only in single purpose tools, the resulting intelligent integration and function selection provided by the invention lowering the cost of performing the functions, and the space consumed by, and weight of, the tools used. While beneficial for all those involved in horse shoeing, this is believed to be especially advantageous for horse owners who will now find it much more practical to purchase a “tool kit” and carry it along with them on rides.

It is to be understood that, while a specific multi-purpose shoeing tool has been shown and described as preferred, other configurations and methods could be utilized, in addition to those already mentioned, without departing from the principles of the invention.

The terms and expressions which have been employed in the foregoing specification are used therein as terms of description and not of limitation, and there is no intention in the use of such terms and expressions to exclude equivalents of the features shown and described or portions thereof, it being recognized that the scope of the invention is defined and limited only by the claims which follow.

1. A multi-purpose shoeing tool, comprising:
a pair of levers pivotally mounted to each other at a pivot point defining a pivot axis, and jaw and handle ends of said levers above and below said pivot axis;
a pair of clinching jaws attached, respectively, to said jaw ends of said pair of levers, said handle ends being cooperatively adapted for leveraging, at said clinching jaws, a force applied to the handle ends for motivating the handle ends toward one another, said clinching jaws being shaped and having respective gripping patterns cooperatively adapted for clinching shoe nails; and
a hammer head attached to a first one of said pair of levers, disposed at the jaw end, and having a substantially planar hammering face defining a hammering axis, the handle ends defining a handle axis, said hammering axis being oriented substantially perpendicular to said handle axis.

2. The tool of claim 1, further comprising a wringing claw attached to a second one of said pair of levers, disposed at said jaw end, and having a hiatus defining substantially “V” shaped wringing edges oriented in a plane that is within about 5 degrees of being parallel to said handle axis.

3. The tool of claim 2, wherein said wringing claw and said hammer head are disposed substantially directly opposite one another, below said clinching jaws.

4. The tool of claim 1, further comprising a hoof-pick/shoe-puller member attached to a distal end of one of said handle ends, said hoof-pick/shoe-puller member being elongate with its elongate axis oriented about 80-100 degrees from said handle axis.

5. The tool of claim 4, wherein an end of said hoof-pick/shoe-puller member is shaped substantially as a standard slotted screw driver blade.

6. The tool of claim 4, further comprising a wringing claw attached to a second one of said pair of levers, disposed at said jaw end, and having a hiatus defining substantially “V” shaped wringing edges oriented in a plane that is within about 5 degrees of being parallel to said handle axis.

7. The tool of claim 1, further comprising a pair of shoe-nail cutting elements, each element of the pair attached to a respective one of said jaw ends, said shoe-nail cutting elements having respective cutting edges and being cooperatively adapted to cut shoe nails.

8. The tool of claim 7, wherein said shoe-nail cutting elements are disposed below said clinching jaws.

9. The tool of claim 1, further comprising a nail-puller including first and second nail-pulling portions, each said nail-pulling portion attached to a respective one of said jaw ends, said nail-pulling portions in a closed configuration of the tool in which said handle ends are at positions of closest approach cooperatively adapted to come into adjacency to provide an aperture permitting receipt of the nail shank while preventing the nail head from passing through.

10. The tool of claim 9, wherein said aperture is substantially square, for pulling shoe nails the shanks of which have a square cross-section, where a corner of said square shaped aperture is positioned at a point of maximum projection from said handle axis relative to the remaining corners of said square shaped aperture.

11. The tool of claim 6, further comprising a pair of shoe-nail cutting elements, each element of the pair attached to a respective one of said jaw ends, said shoe-nail cutting elements having respective cutting edges and being cooperatively adapted to cut shoe nails.

12. The tool of claim 6, further comprising a nail-puller including first and second nail-pulling portions, each said nail-pulling portion attached to a respective one of said jaw ends, said nail-pulling portions in a closed configuration of the tool in which said handle ends are at positions of closest approach cooperatively adapted to come into adjacency to provide an aperture permitting receipt of the nail shank while preventing the nail head from passing through.

13. The tool of claim 12, further comprising a pair of shoe-nail cutting elements, each element of the pair attached to a respective one of said jaw ends, said shoe-nail cutting elements having respective cutting edges and being cooperatively adapted to cut shoe nails.

14. The tool of claim 2, further comprising a hoof-pick/shoe-puller member attached to a distal end of one of said handle ends, said hoof-pick/shoe-puller member being elongate with its elongate axis oriented about 80-100 degrees from said handle axis.

15. The tool of claim 14, wherein an end of said hoof-pick/shoe-puller member is shaped substantially as a standard slotted screw driver blade.

16. The tool of claim 15, further comprising a pair of shoe-nail cutting elements, each element of the pair attached to a respective one of said jaw ends, said shoe-nail cutting elements having respective cutting edges and being cooperatively adapted to cut shoe nails.

17. The tool of claim 16, further comprising a nail-puller including first and second nail-pulling portions, each said nail-pulling portion attached to a respective one of said jaw ends, said nail-pulling portions in a closed configuration of the tool in which said handle ends are at positions of closest approach cooperatively adapted to come into adjacency to provide an aperture permitting receipt of the nail shank while preventing the nail head from passing through.

18. The tool of claim 14, further comprising a nail-puller including first and second nail-pulling portions, each said nail-pulling portion attached to a respective one of said jaw ends, said nail-pulling portions in a closed configuration of the tool in which said handle ends are at positions of closest approach cooperatively adapted to come into adjacency to provide an aperture permitting receipt of the nail shank while preventing the nail head from passing through.

19. A multi-purpose shoeing tool, comprising:
a pair of levers pivotally mounted to each other at a pivot point defining a pivot axis, and jaw and handle ends of said levers above and below said pivot axis;
a pair of clinching jaws attached, respectively, to said jaw ends of said pair of levers, said handle ends being cooperatively adapted for leveraging, at said clinching jaws, a force applied to the handle ends for motivating the handle ends toward one another, said clinching jaws being shaped and having respective gripping patterns cooperatively adapted for clinching shoe nails; and
a wringing claw attached to a second one of said pair of levers, disposed at said jaw end, and having a hiatus defining substantially “V” shaped wringing edges oriented in a plane that is within about 5 degrees of being parallel to said handle axis.

20. A multi-purpose shoeing tool, comprising:
a pair of levers pivotally mounted to each other at a pivot point defining a pivot axis, and jaw and handle ends of said levers above and below said pivot axis;
a pair of clinching jaws attached, respectively, to said jaw ends of said pair of levers, said handle ends being cooperatively adapted for leveraging, at said clinching jaws, a force applied to the handle ends for motivating the handle ends toward one another, said clinching jaws being shaped and having respective gripping patterns cooperatively adapted for clinching shoe nails; and
a hoof-pick/shoe-puller member attached to a distal end of one of said handle ends, said hoof-pick/shoe-puller member being elongate with its elongate axis oriented about 80-100 degrees from said handle axis.

21. A multi-purpose shoeing tool, comprising:
a pair of levers pivotally mounted to each other at a pivot point defining a pivot axis, and jaw and handle ends of said levers above and below said pivot axis;
a nail-puller including first and second nail-pulling portions, each said nail-pulling portion attached to a respective one of said jaw ends, said nail-pulling portions in a closed configuration of the tool in which said handle ends are at positions of closest approach cooperatively adapted to come into adjacency to provide an aperture permitting receipt of the nail shank while preventing the nail head from passing through; and
a hammer head attached to a first one of said pair of levers, disposed at the jaw end, and having a substantially planar hammering face defining a hammering axis, the handle ends defining a handle axis, said hammering axis being oriented substantially perpendicular to said handle axis.
